(19) United States
(12) Patent Application Publication
(10) Pub. No.: US 2016/0050468 A1
(43) Pub. Date: Feb. 18, 2016

(54) MITIGATION OF COLLUSION ATTACKS AGAINST WATERMARKED CONTENT

(71) Applicant: NAGRAVISION S.A., Cheseaux-Sur-Lausanne (CH)

(72) Inventors: Glenn Morten, Bellevue, WA (US); Charles Michael Fish, New Hope, PA (US)

(21) Appl. No.: 14/460,244

(22) Filed: Aug. 14, 2014

(51) Int. Cl. H04N 21/8358; H04N 21/2343; H04N 21/254; H04N 21/235

(52) U.S. Cl. CPC H04N 21/8358; H04N 21/235; H04N 21/2343; H04N 21/2541

(57) ABSTRACT

Media content containing a substantially invisible watermark and/or a fingerprint may be redistributed/retransmitted in a way that bypasses bypass the detectability of a hidden or invisible watermark or fingerprint. In particular, a first segment of media content may be received by a first receiver and a second segment of media content may be received by a second server. The first and second segments may be stored on a storage device. The first and second segments may be made available to a client in the form of a concatenated media content.

### TECHNICAL FIELD

This document relates to audio video content security and digital watermarking.

### BACKGROUND

Watermarking of content generally refers to techniques in which a particular copy of media either transmitted via a network or stored on a storage medium is marked with digital identification, sometimes called a watermark that is specific to that copy. The watermark may or may not be perceptible (e.g., audible or visible) during normal use of the content by a user for listening to audio or viewing the image or video data. The watermark may be used for source identification, e.g., to determine a particular user device (e.g., a cable or a satellite receiver) that is the source of the content or a particular media (e.g., a compact disc) on which the content was stored.

### SUMMARY

The present document describes ways in which some users may attempt to circumvent data security of watermarked content and techniques by which to defeat such attempts. In one possible attempt to circumvent watermark-based security, multiple colluding receivers may be used together with a streaming media server with which content is made available to downstream user devices in form of downloadable segments and an index file that provides information about locations of the downloadable content segments. The disclosed technology provides for techniques that overcome such collusions attacks and others.

In one example aspect, a method of redistributing media content is disclosed. The method includes generating, using a first receiver, a first segment of a media content comprising a first watermark, generating, using a second receiver, a second segment of the media content comprising a second watermark that is different from the first watermark, storing, using a storage device, the first segment and the second segment and making available the first segment of the media content from the first receiver and the second segment of the media content from the second receiver to a client device as a concatenated media content.

In another example aspect, an apparatus for redistributing media content is disclosed. The apparatus may include a first receiver, a second receiver, and a storage device. The first receiver receives a first segment of the media content. The second receiver receives a second segment of the media content. The storage device stores the first segment of the media content from the first receiver and the second segment of the media content from the second receiver as a concatenated media content.

In yet another example aspect, a non-transitory machine readable storage medium encoded with instructions for performing a method of redistributing media content is disclosed. Instructions may be included for a first segment of the media content to be received using a first receiver. Instructions may be included for a second segment of the media content to be received using a second receiver. Instructions may be included for the first segment and the second segment to be stored using a storage device. Instructions may be included for the first segment of the media content from the first receiver and the second segment of the media content from the second receiver as a concatenated media content to be made available to a client device, e.g., using a retransmitter over a network connection or after writing the media content to a playback media.

Those and other aspects, features and their implementations are described below in the drawings, the description and the claims.

### BRIEF DESCRIPTION OF THE DRAWINGS

FIG. 1 depicts an example of a media content delivery system.

FIG. 2 depicts an example of an architecture for redistributing media content.

FIG. 3 depicts examples of techniques that allow delivery of a payload of a hidden watermark in a condensed amount of time.

FIG. 4 depicts an example of a series of concatenated media content frames with subliminal messages spread amongst the frames.

FIG. 5 is a flowchart representation of an example technique for redistributing media content.

FIG. 6 is a block diagram of an example of an apparatus for making content available to user devices.

### DETAILED DESCRIPTION

With recent advances in digital content storage and distribution technologies, unauthorized reproduction and sharing of digital content has also grown. To combat digital piracy, several technologies have been developed, including technologies to prevent unauthorized copying of content or to detect the source device from which a copied content originates from to take measures to deactivate the source device.

Watermarking generally refers to techniques to mark a piece of content, e.g., a television program or a digital audio track, with an identification that is embedded with the content. The identification may be unique enough to trace the piece of content to a specific user device or a specific storage medium on which the content was originally distributed by the content owner. In some watermarking techniques, a watermark may be embedded in the media content to identify the authorized recipient of the media content. The watermark may be visible or audible (and perceptible to the user viewing or listening to the media content) or may be hidden (invisible or inaudible) within the media content.

A visible or perceptible watermark may degrade the quality of the media content (e.g., by disrupting the video viewing experience of a user) and can be removed or obscured by the receiver. A hidden or invisible watermark may require a comprehensive analysis of the source content and a complex detection process that may require processing over several frames of the media content (e.g., frames of video), which is sometimes called the watermarking detection period. A hidden watermark may be sent as a payload that inserted at different times, e.g., over many frames of media content. In some content networks, e.g., broadcast satellite or internet protocol television (IPTV) networks, a piece of content, e.g., television program may be provided to millions of subscriber devices. The watermark would therefore be unique enough (and long enough) to uniquely identify millions of different individual copies of the piece of content. A watermark payload may thus be spread over a long duration of the content (e.g., 30 seconds to 2 minutes) to include an identifier that has non-repudiation properties (which could allow it to be used as evidence, e.g., against pirates of the media content) and that account for error correction (e.g., to overcome packet loss). Put differently, to forensically identify with a given level of confidence (e.g., with 99.999% percent probability) which particular subscriber device a particular piece of content was originally sent to may need tens of seconds, typically two minutes or more, of content. When a portion of content having duration shorter than this watermarking detection period is available, analysis of the content to identify the watermark contained within the content may either be not possible or may have a low probability of being able to uniquely identify the watermark. Furthermore, forensic analysis of the content to detect and reliably extract the watermark embedded in the content often requires contiguous availability of content—e.g., availability of all (or substantially all) back-to-back video frames over the watermark detection period. A break in the content continuity may make it hard or impossible to extract the content. The techniques presented in this document can be used, among other uses, to overcome these limitations and others.

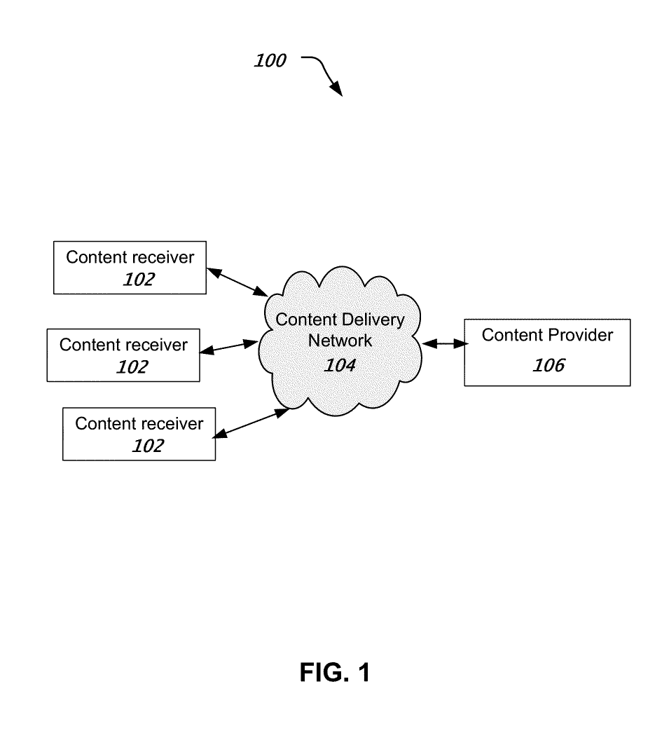

FIG. 1 illustrates a network architecture 100 in which content receivers 102 are communicatively coupled to a content delivery network 104 and configured to receive media content from a content provider 106. The content provider may include and be the source of media content (e.g., video). For example, media content provider 106 may be operated by any content delivery operator (e.g., cable providers such as Time Warner and Cox, satellite television operators such as DirecTV, etc.).

In FIG. 1, a content receiver 102 may be in various configurations, e.g., a unit that is external to or could be included within a standalone set-top box. The set-top box may be coupled to or may include within it a storage device (e.g., a personal video recorder PVR or a digital video recorder DVR), a computer, a smartphone, a tablet computer and so on. The content delivery network 104 may be one of various suitable networks for delivering digital contents, e.g., a fiber to the curb network, a hybrid fiber coaxial cable network, a satellite network, a wireless network, the Internet and so on.

In some embodiments, media content containing a substantially invisible watermark may be redistributed or retransmitted in a way that bypasses the detectability of a hidden or invisible watermark. In particular, a first segment of media content may be received by a first receiver and a second segment of media content may be received by a second server. The first and second segments may be stored on a storage device. The first and second segments may be made available to a client in the form of concatenated media content. In some embodiments, the these steps, discussed above, of receiving the first and second segments, storing these segments, and making the segments available to a clients may be encoded on a machine readable media.

In some embodiments, an apparatus for redistributing media content may include a first receiver, a second receiver, and a storage device. The first receiver receives a first segment of the media content. The second receiver receives a second segment of the media content. The storage device stores the first segment of the media content from the first receiver and the second segment of the media content from the second receiver as concatenated media content.

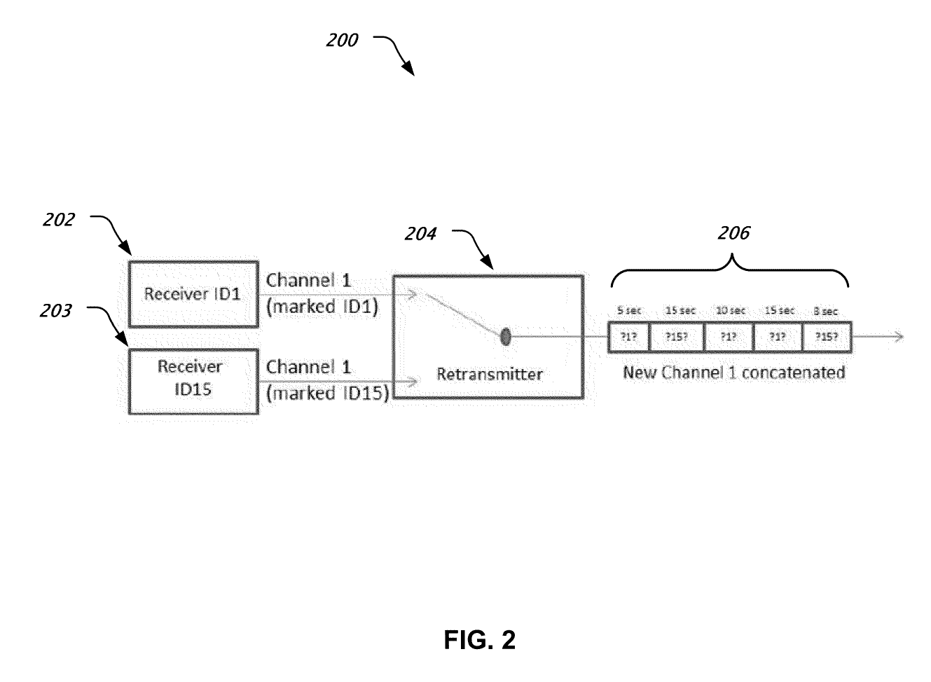

FIG. 2 illustrates an example of architecture 200 for redistributing media content. In architecture 200, multiple receivers 202, 203 are communicatively coupled to a retransmitter 204. Each receiver 202, 203 may be similar in form and in function to content receiver 102 of FIG. 1. Each receiver 202, 203 may be configured to receive media content (e.g., video) from a content provider (e.g., content provider 106 of FIG. 1). A hidden watermark may be sent as a payload that inserted over a period of time, e.g., over many frames of media content. For example, the hidden watermark payload could be inserted such that content over 30 seconds to 2 minutes may have to be accumulated in order to be able to detect the inserted watermark with high reliability.

The receiver 202 may produce, at its output, content that gets marked with a watermark of identification ID1. The receiver 203 may produce, at its output, content that gets marked with a watermark having identification ID15. If a user were to simply retransmit the content at the output of the receiver 202 or 203 by itself (i.e., without mixing together the two outputs), this content could be analyzed to extract the watermark (ID1 or ID15) and the source receiver of the content can be easily detected to be either receiver 202 or receiver 203.

To defeat such a straightforward detection, a retransmitter 204 may generate content by periodically switching the retransmission between the received media content from the receivers 202, 203. In particular, by switching to the first receiver, the retransmitter may take a first segment of the media content that was received using the first receiver. By switching to the second receiver, the retransmitter may take a second segment of the media content that was received using the second receiver. The switching may be optimally “seamless” (i.e., with little or no delay) or the switching may be less than perfectly “seamless.”

The retransmitter 204 may switch (possibly in any order) between the multiple receivers 202 at a random switching rate or at a fixed switching rate. Typically, the retransmitter 204 may not be aware of whether or not a watermark is introduced in the content at outputs of 202, 203 and the retransmitter 204 typically may not know what the watermark detection period of the inserted watermark (if any) is. By chance, if the retransmitter's content switching rate is faster than the watermark detection period for the hidden watermark, it may become hard or impossible to detect which rogue receivers are being used to generate or redistribute the media content at the output of the retransmitter.

Such use of architecture 200, as described with reference to FIG. 2, may thus render the payload, and hence the watermark, unrecognizable with a high degree of confidence. Such use of architecture 200 may allow users to bypass the detectability of a hidden or invisible watermark that is received. Therefore, the use of architecture 200 to redistribute/retransmit media content may allow for authentication of the source of the media content to be evaded and may also allow for the repudiation by the true source of the media content.

The retransmitter 204 may include any suitable storage device (not shown). For example, the storage device may include any volatile and/or non-volatile computer memory or storage devices such as a hard disk, floppy disk, USB drive, DVD, CD, media cards, register memory, processor caches, Random Access Memory (“RAM”), etc. The storage device may be used to store the concatenated media content 206. In addition, retransmitter 204 may include or make use of an index file that indexes the different segments of the media content received by the multiple receivers 202. For example, the index file could have a first index associated with the first segment of media content received by a first receiver and a second index associated with the second segment of media content received by the second receiver. For example, the indices may each be pointers that are used to reference a particular segment or segments. As another example, the indices may be links or Universal Resource Locators (URLs) that may each be used to reference a particular segment or segments. The index file may be used to determine the order in which the segments are concatenated within the concatenated media content 206. For example, the index file may indicate that the first segment of media content is to be concatenated onto the end of the second segment of media content prior to or during retransmission or storage of the media content.

The concatenated media content 206 may be made available to any client device that requests the content. For example, the media content 206 may be made available to a client device over a network connection or via the Internet. As another example, the media content 206 may be made available by being written to a playback media. The playback media may be any media capable of storing data. The playback media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

The retransmission techniques described in this document, in one aspect, exploit the weakness of some watermarking techniques in that these techniques embed watermark into the content over a long duration of time, and unless content over that duration is contiguously available (e.g., a number of back-to-back video frames), detection of the watermark may not be possible. The retransmission may be performed over the Internet using an off-the-shelf media streaming technology such as the Hypertext Transfer Protocol (HTTP) Live Streaming (HLS) or the MPEG Dynamic Adaptive Streaming over HTTP (DASH) streaming technologies. Fortuitously for a retransmitter, these streaming technologies are based on segment-by-segment transmission of content, and many commercially available streaming servers readily can be used to assemble content into segments of video of different durations and making the content available to downstream user devices, as further described below.

The aforementioned HLS technique is used for illustrative description below, but other streaming media techniques operate similarly. In HLS-based streaming, a streaming media server makes available content to a client device in the form of multiple downloadable segments that can be requested by the client device. For example, a two-hour movie may be organized as 1,440 video segments, each having 10 second playback duration. When a client device requests the movie for viewing, the server initially sends an index file that lists locations (universal resource locators or URLs) at which these segments can be obtained from. The server sometimes stores multiple quality copies of each video segment. For example, the index file may list 1,440 URLs for a first quality (e.g., 6 Mbits/second bitrate) and another 1,440 URLs for video content at a second quality (e.g., 1 Mbits/second bitrate). The client device, based on the runtime conditions, can request every next segment of 10-second duration from the server, on as needed basis to ensure the client device has sufficient content for a glitch-less playback.

The retransmitter 204 can make use of segment-based streaming such as the HLS technique by mixing in video segments from different receivers 202, 203, which are advertised to a client device as an index file of video segments, without the client device having to know which receiver generated which video segment. Often, receivers 202, 203 only generate analog video outputs. The retransmitter 204 can thus include a module that achieves frame-accurate synchronization of the analog outputs of receivers 202, 203, digitize the analog outputs, encode the outputs using a video compression algorithm (e.g., H.264 or VP-8) to create video segments of certain durations, store the video segments in a storage, and generate an index file in which the URLs mix together segments generated from receiver 202 and 203 such that playing back the content by concatenating the video segments based on the index file provides seamless viewing experience at the user device. To disrupt detection a watermark, if any, in the generated video segments, the retransmitter 204 may use a first technique in which the duration of segment is non-uniform (e.g., a randomly selected value between 5 seconds and 30 seconds). Another technique used by the retransmitter 204 may be to add disruptive frames in the segments. For example, a 10-second video segment, which corresponds to 300 video frames, generated from the output of receiver 202 may be punctured at frame numbers 100 and 200 by replacing these frames with the corresponding frames from 203.

One way in which content piracy based on the retransmission/streaming media techniques can be combated is by using a watermark detection period that is sufficiently small such that, in spite of the mixing of content from multiple receiver via the use of segments, identities of the source receivers can be established by analyzing the concatenated media output provided by the retransmitter. The inventors noticed that, to be practical, typical retransmission techniques use content segment sizes that are at least several seconds long (at least 3 seconds, and typically 10 seconds or more). In general, the longer the size of a content segment, the better the quality of the encoded (compressed) content can be. One reason for improvement in quality when a longer duration of segment is used is because number of bits used on a per-frame basis can be averaged out over the high action/low action mix of video frames over a longer duration. The segments, of course, cannot be too long, because it could lead to undesirable channel change delays due to long buffering wait times.

One possible solution to thwarting the retransmission/streaming media based content piracy is to make the watermark duration have a short period, e.g., less than 3 seconds or 1 second or even a single frame duration. When a watermark can be completely detected even with such a small duration burst of content, then interwoven segment output of a retransmitter can be analyzed and the source receiver devices 202, 203 can be determined with a high degree of confidence.

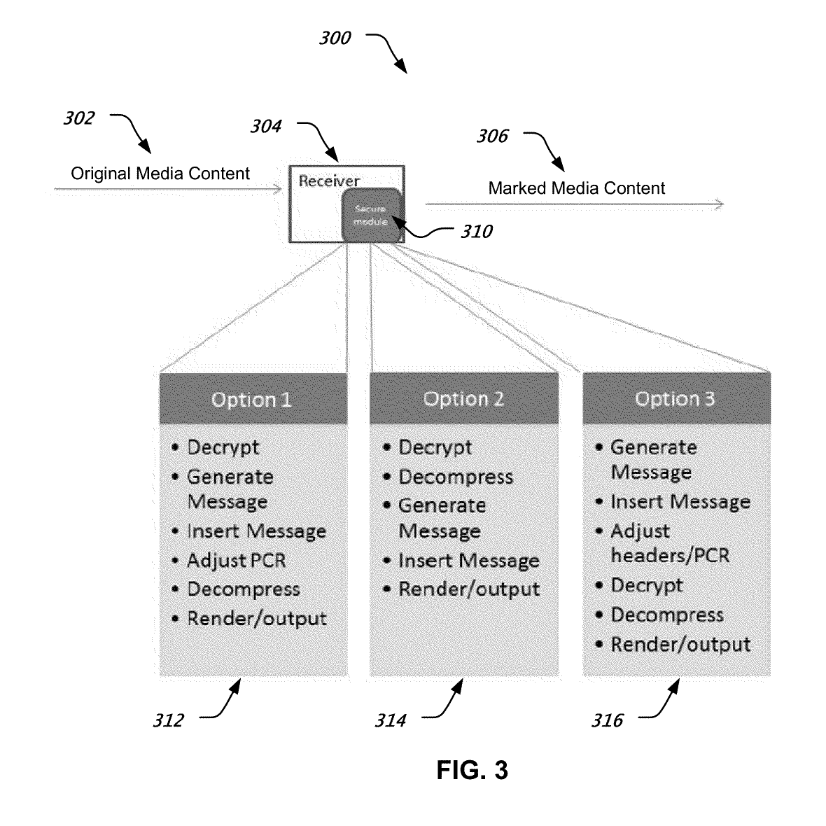

FIG. 3 illustrates an example of an architecture 300 and a set of techniques (e.g., 312, 314, or 316) that allow a user to deliver a payload of a hidden watermark in a short amount of time (e.g., in a single frame of media content such as video or in less than one second of time). A visible watermark in media content may degrade the quality of the media content and because a visible watermark can easily be detected and defeated (e.g., by obscuring or removing the watermark) by a user wishing to pirate the media content. In addition, a hidden watermark may be bypassed using the architecture and technique as discussed with reference to FIG. 2.

Thus, one solution may be to leverage “subliminal messaging” within the media content. In particular, frames of the media content may be interlaced with a payload (which may be or included within a subliminal message) associated with hidden watermarks at a rapid rate. Architecture 300 includes receiver 304, which may be similar in form and in function to any one of receivers 102 and/or 202, 203 described above.

Receiver 304 may receive original media content 302 and may convert it to marked media content 306 after inserting subliminal messages (i.e., messages containing payloads associated with hidden watermarks) into original media content 302. In particular, receiver 304 may insert a subliminal message within a picture or other frame within the original media content 302 at a rapid rate (e.g., faster than one second of time per message). For example, the rate at which messages are inserted may be faster than a fastest possible switching rate (as described with reference to FIG. 2) between receivers.

Receiver 304 may include a secure module or processor 310 that employs one of a few different techniques (e.g., 312, 314, or 316) to process the original media content 302 in order to create the marked media content 306. Subliminal messages (each including a watermark payload) may include numbers. However, images such as pictures may be used as subliminal messages in the place of numbers. For example, a particular picture may represent a particular number (i.e., there may be a one-to-one relationship between any number and a picture). More generally, a subliminal message (which may include a watermark payload) may include any symbol or set of symbols. However, an image such as a picture may be used as a subliminal message in place of a symbol or set of symbols (i.e., there may be a simple mapping of symbols to images). The symbols or the images may be used to (possibly uniquely) identify the particular source of the marked media content. The images that are used as subliminal messages may be imperceptibly displayed when the media content is displayed. The frequency with which the subliminal messages are displayed and the length of the period of time that the subliminal messages are displayed may be randomly adjusted. For example, these parameters may be adjusted to mitigate the risk that the subliminal messages may be detected. As another example, these parameters may be adjusted to indicate different sources of the media content.

The generation and insertion of a subliminal message may be performed at the receiving device/receiver 304 or may be performed within the cloud (i.e., networked computer resources) from which the original media content is received. Such generation and insertion may require limited processing resources and may not require additional bandwidth, unlike in some modern systems. However, for additional security, it may be describable to perform the generation and frame insertion of subliminal messages within the secure module or processor 310 or with the use of a secure client device (that is, e.g., coupled to the receiver 304). The secure module or processor 310 may be shared by the conditional access subsystem of the receiver 304. Using the secure module or processor 310 or a secure client, different techniques may be used to embed any subliminal message (that includes the payload associated with a watermark) into original media content 302 in order to produce marked media content 306. In particular, each of the different techniques may include a different ordering of functions involved in processing original media content 302 to produce marked media content 306.

In a first technique 312, the original media content 302 may first be decrypted. A subliminal message may be generated based on an a priori algorithm or control messages received from the content network. The subliminal message may be inserted into the media content. The subliminal message may be designed to uniquely identify the receiver 304, e.g., by using a unique serial number of the receiver. The Program Clock Reference (PCR) may be adjusted to take into account the increased number of packets in the stream due to the addition of the subliminal message. The PCR-adjusted media content may then be decompressed, and the decompressed media content may be rendered and output at marked media content 306. The output thus includes a subliminal watermark, introduced at the receiver 304, that uniquely identifies the source of the content as being the receiver 304.

In a second technique 314, the original media content 302 may be decrypted and decompressed to generated uncompressed media content. A subliminal message may be generated and inserted into the uncompressed media content. The media content may be rendered and output at marked media content 306. As with technique 312, the marked media content includes a watermark that uniquely identifies the receiver 304 as being the source device for the media content.

In a third technique 316, a subliminal message may be generated, the message may be inserted into the original media content 302, the Program Clock Reference (PCR) and headers of the media content may be adjusted. The PCR-adjusted stream may then be decrypted and decompressed and sent out as marked media content 306.

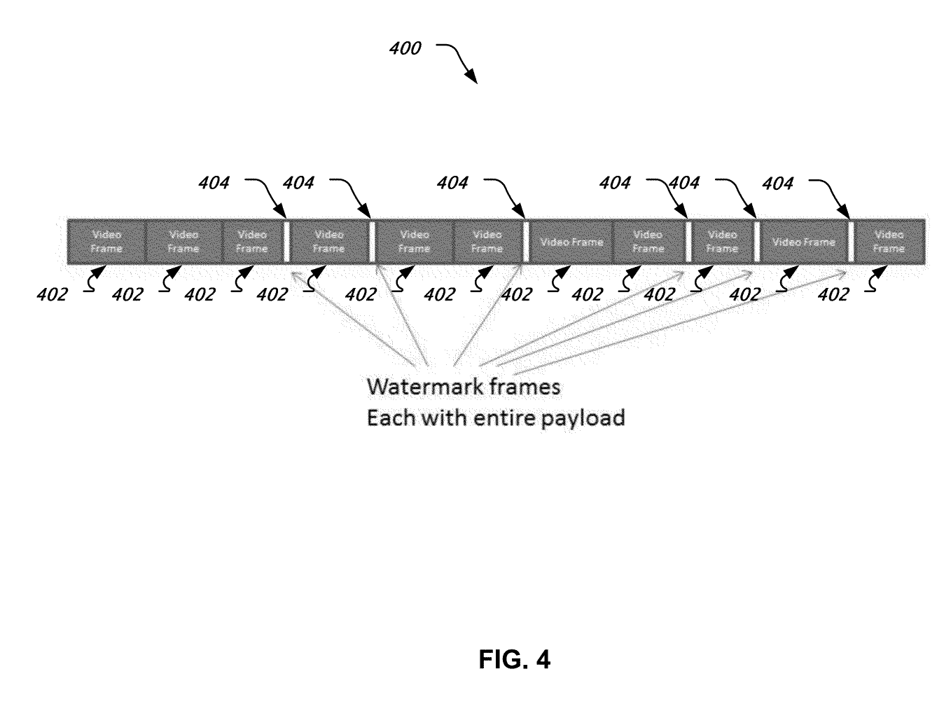

FIG. 4 depicts an example of a series of concatenated media content frames 400 with subliminal messages 404 spread amongst the individual frames 402. As discussed above, subliminal messages may be imperceptibly displayed and/or interspersed amongst media content frames prior to or when the media content is displayed. Each subliminal message may include the entire payload associated with a watermark, rather than the payload being spread across multiple subliminal messages or video frames.

The concatenated media content frames 400 may form a portion or a segment of the overall media content. Some of the frames individual media content frames 402 that comprise frames 400 may include a subliminal message 404 that either precedes or follows the individual frame. As can be seen in FIG. 4, the frequency with which the subliminal messages are interspersed or displayed may be randomly adjusted. In addition, the length of the period of time that the subliminal messages are displayed may be randomly adjusted. For example, these parameters may be adjusted to mitigate the risk that the subliminal messages may be detected. As another example, these parameters may be adjusted to indicate different sources of the media content.

The short period watermarking technique (e.g., single-frame water mark insertion) can be advantageously used to vary operational parameters to further increase robustness of the technique. To highlight this advantage, two alternate watermarking schemes can be compared as follows: Scheme 1, in which a conventional watermarking technique that needs 150 back-to-back frames (approximately equal to 5 seconds of video) to uniquely identify the source of the content; and Scheme 2, that insert a uniquely identifiable watermark in a single frame of video.

It may appear that Scheme 2 would need higher bandwidth or computational overhead, or may reduce the bandwidth available for content, to make space to insert the watermarks in each frame. This, however, need not be the case.

Since watermark detection needs only a single video frame, Scheme 2 need not insert a watermark in each frame. Using Scheme 2, a watermark may be introduced every 150 frames (roughly matching the overhead of Scheme 1). Even at this level, Scheme 2 will still provide superior operational efficiency because unlike Scheme 1, which requires 150 back-to-back frames to make a forensic watermark determination, Scheme 2 doesn't have the strict requirement of back-to-back frames, any sampling pattern of 150 or so frames may be sufficient. Additionally, in some embodiments, the watermarked frames may be inserted with a random number of frames separating the watermarked frames, thereby making it quite possible to perform forensic detection using a minimal number of frames. In real life applications, if pirated content (unauthorized duplicates) or a rogue retransmitter that is providing content over the internet is found, many minutes of content (which translates to several thousand frames of video) may be available for analyzing for the source of the pirated content. Scheme 1, however, may still fail to uniquely detect the source receivers if the streaming server uses a segment length that is shorter than 5seconds. In other words, in spite of having several minutes worth content, Scheme 1 may still prove unsatisfactory because the content lacks 5 seconds of back-to-back frames having the same watermark (generated from the colluding rogue receiver). By contrast, a variable short duration watermarking scheme, such as described with respect to FIG. 3 and FIG. 4, would have no problem identifying the rogue receiver because it requires only a few (or just one) back-to-back frames that contain the same watermark.

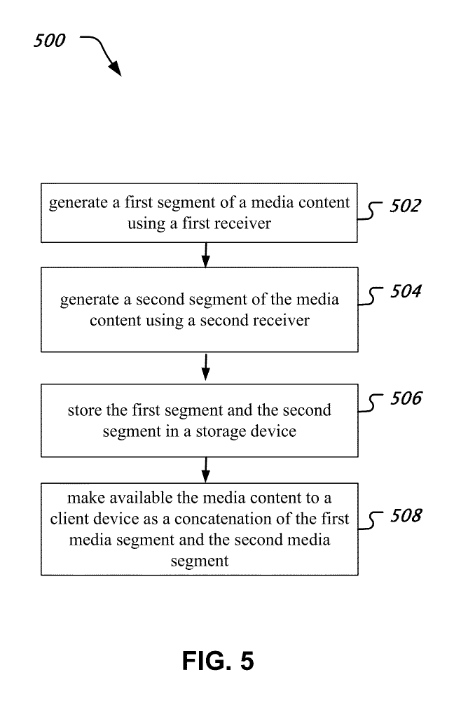

FIG. 5 is a flowchart representation of an example of a technique 500 for redistributing media content. The technique 500 may be used for rendering a media content having a watermark unrecognizable by operating multiple receivers to collude to generate the media content. Technique 500 may allow users to bypass the detectability of a hidden or invisible watermark that is received. Therefore, the use of technique 500 to redistribute/retransmit media content may allow for authentication of the source of the media content to be evaded and may also allow for the repudiation of the source of the media content.

In some embodiments, each of multiple receivers (e.g., receivers 202 of FIG. 2) may be configured to generate uncompressed media content by receiving the media content (e.g., video) from a content provider (e.g., content provider 106 of FIG. 1) in a compressed format (e.g., MPEG encoded or H.264 encoded, and so on). The media content may include a hidden watermark. The hidden watermark may be inserted at a level that may have a watermarking recognition period that extends over several 100 video frames.

A retransmitter (e.g., retransmitter 204 of FIG. 2) coupled to each of the multiple receivers may switch between the multiple receivers and may switch between the received media content from each of the receivers. The retransmitter may switch (possibly in any order) between the multiple receivers at a random switching rate or at a fixed switching rate that is faster than the payload insertion rate for the hidden watermark.

At 502, a first segment of media content may be generated using a first receiver. The first segment of media content may include a first watermark. The first watermark may be used for detection of the first receiver in a forensic analysis.

At 504, a second segment of media content may be generated using a second receiver. In some embodiments, the generation of the first segment may be performed by receiving the media content via a network interface in a compressed format, decompressing the media content and inserting the first watermark to create media content in an uncompressed format, and re-encoding the media content in the uncompressed format to generate the first segment. For example, in some embodiments, the first receiver may be an IPTV, a satellite or a cable receiver that receives content from the Internet, a satellite interface or a digital cable network interface. The content may be encrypted and may be compressed in one of many possible audio video compression formats. The first receiver may receive the compressed content; decompress the content into a decompression format (e.g., YCrCb format, or s-video format, or Dl digital format, and so on). The content may then be re-encoded into the first segment. In some embodiments, multiple copies of the first segment, e.g., at multiple bitrate or quality levels, may be generated.

The first segment may be of a first length and the second segment may be of a second length. The lengths of the first and the second segments may be different or may be substantially the same. The lengths of each of the first and second segments in the concatenated media content may be less than the watermark detection period associated with the hidden watermark.

At 506, the first segment and the second segment of the media content may be stored in a storage device (which may be included within or external to the retransmitter). For example, the storage device may include any volatile and/or non-volatile computer memory or storage devices such as a hard disk, floppy disk, USB drive, DVD, CD, media cards, register memory, processor caches, Random Access Memory (“RAM”), etc. To facilitate adaptive transmission of the media content downstream to a client device, the first segment and the second segment may also have corresponding copies at different bitrates, as is well-known in media streaming systems. In some embodiments, an index file, e.g., an m3u8 file for an HLS implementation may be provided to the client device. Using the index file, the first segment and the second segment may be concatenated in any order prior to being displayed by the client device.

In some embodiments, the segments of media may be temporarily stored in the storage device, e.g., in a volatile memory buffer, to facilitate transmission to client devices and may be deleted after transmitting the segments to client devices. The freed up storage space up may be re-used to temporarily store next incoming storage content. For example, in some embodiments, about 10 segments of video may be stored in the storage device at a given time, to allow for buffering of content during the time the retransmitter 204 makes the content available to client devices and the time when the retransmitter 204 receives requests for specific segments and transmits the segments to the client devices. In some embodiments, the segments may be stored for a longer duration (e.g., for a week to several months) for future distribution and use of the content. For example, in some embodiments, entire content of a program such as a 1 hour television show or a 2 hour movie may be stored in the storage device for subsequent use. Alternatively, in some embodiments, content for the 1 hour television show or the 2 hour movie may be deleted from the storage device as soon as the last segment of the content is transmitted by the retransmitter 204.

At 508, the first segment of the media content from the first receiver and the second segment of the media content from the second receiver may be made available to a client as a concatenated media content (e.g., concatenated media content 206 of FIG. 2). For example, the concatenated media content may be made available to a client device over a network connection or via the Internet. As another example, the concatenated media content may be made available by being written to a playback media. The playback media may be any media capable of storing data. The playback media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

In addition, making the concatenated media content available, at 508, may include the use of an index file that indexes the different segments of the media content received by the multiple receivers. For example, the retransmitter and/or storage device may make use of such an index file when the concatenated media content is made available. For example, the index file could have a first index associated with the first segment of media content received by a first receiver and a second index associated with the second segment of media content received by the second receiver. For example, the indices may each be pointers that are used to reference a particular segment or segments. As another example, the indices may be links or Universal Resource Locators (URLs) that may each be used to reference a particular segment or segments. The index file may be used to determine the order in which the segments are concatenated within the concatenated media content. For example, the index file may indicate that the first segment of media content is to be concatenated onto the end of the second segment of media content prior to or during retransmission or storage of the media content. In some embodiments, the media content may be live and the index file may be updated from time to time as more and more of the live content becomes available.

It should be understood that the above steps of the described technique may be executed or performed in any order or sequence not limited to the order and sequence shown and described in the preceding figures. Additionally, some of the above steps may be executed or performed substantially simultaneously where appropriate or in parallel to reduce latency and processing times.

In some embodiments, a method of defeating a collusion piracy attack includes providing content to a plurality of receiver devices, wherein the content includes watermarking information, the watermarking information is of a form that can be detected and analyzed to uniquely determine the source copy based on analysis of a single video frame of watermarked video content. In some embodiments, the watermarking detection duration may be made adaptable. For example, when a content provider or a content owner suspects that content is being pirated using a collusion based attack (e.g., using the retransmitter 204), an off-line determination may be made about the smallest segment duration being used by the pirates for the unauthorized data streaming. The determination that a collusion based attack is being made may be performed based on analysis of content that is known to have been watermarked, but fails to provide a reliable watermark after forensic analysis. Further, the determination of the smallest segment size (e.g., 3 seconds or 5 seconds duration) used by pirates can be made simply by analyzing the information includes in the index file. Upon the determination that content is being compromised by segment-based streaming in which segments from different authorized receiver devices are being interweaved, future transmission of content to the suspect receivers may be adapted to have a watermark detection period that is smaller than the observed smallest segment duration in the pirated content.

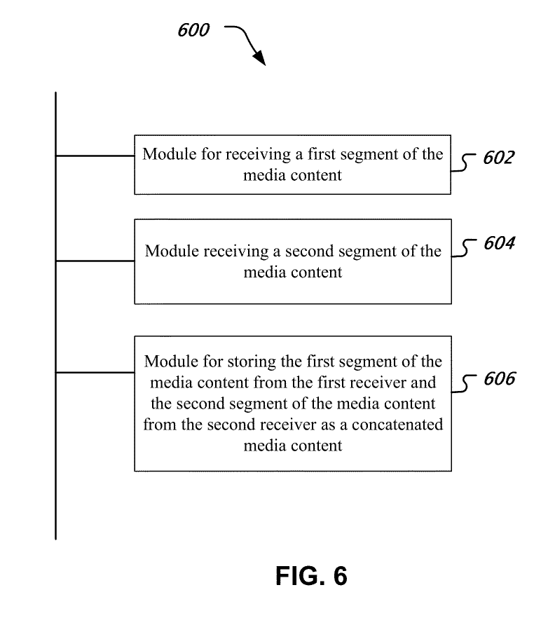

FIG. 6 depicts a block diagram of an example of an apparatus 600 for making content available to user devices. The apparatus 600 may be implemented, e.g., in the system example depicted in FIG. 2. The module 602, e.g., a first receiver such as a cable or a satellite set-top box or an IPTV receiver hardware or software for receiving a first segment of the media content. The module 604, which may be implemented similar to the module 602, is for receiving a second segment of media content. The module 606, e.g., a storage device, is for storing the first segment of the media content from the first receiver and the second segment of the media content from the second receiver as a concatenated media content. In some embodiments, a watermark payload is associated with the media content. The watermark payload may be inserted at a rate that corresponds to a first period of time of the media content. The first period of time may be, e.g., between a few seconds (5 seconds) to a few minutes (2minutes). In some embodiments, the first segment may have a second period of time of the media content that is shorter than the first period of time of the media content. For example, the first segment may have a time duration of 5 seconds, when the second time period (e.g., watermarking detection period) has a duration of 20 seconds. In some embodiments, the second segment may have a duration of a third period of time that is also shorter than the first time period that corresponds to the watermarking detection period.

In some embodiments, the apparatus 600 device uses an index file, wherein the index file comprises a first index associated with the first segment and a second index associated with the second segment. The index file may be, e.g., an m3u8of an MPEG-DASH XML description file. In some embodiments, the index file is used to determine an ordering of the segments in the concatenated media content.

In some embodiments, the apparatus 600 may use more than two receivers whose content output may be concatenated or interweaved to further confuse any forensic attempts to detect watermarks. For example, in some embodiments, additional receivers, e.g., a third receiver for receiving a third segment of the media content; and wherein the concatenated media content further includes the additional segments, e.g., the third segment, generated by the additional receivers. In some embodiments, at least one additional receiver (e.g., one to ten additional receivers) for receiving at least one additional segment of the media content may be used. In such an embodiment, the concatenated media content will be generated by including additional segment of the media content that are output from the additional receivers.

The disclosed and other embodiments, the functional operations and modules described in this document (e.g., receivers, retransmitter, storage devices, processors, media content processing devices, etc.) can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The techniques and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The various modules (e.g., the receivers, retransmitter, etc.) described herein, any of the techniques disclosed above, and the embodiments described herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of redistributing media content, comprising:
generating, using a first receiver, a first segment of a media content comprising a first watermark;
generating, using a second receiver, a second segment of the media content comprising a second watermark that is different from the first watermark;
storing, using a storage device, the first segment and the second segment; and
making available the first segment of the media content from the first receiver and the second segment of the media content from the second receiver to a client device as a concatenated media content.

2. The method of claim 1, wherein the making available comprises creating an index file, wherein the index file comprises a first index associated with the first segment and a second index associated with the second segment, and transferring the index file to the client device upon receiving a request for the concatenated media content.

3. The method of claim 2, wherein the index file includes entries listing an ordering of the segments in the concatenated media content.

4. The method of claim 1, wherein the generating the first segment includes:
receiving the media content via a network interface in a compressed format;
decompressing the media content to produce a media content in an uncompressed format;
inserting the first watermark into the media content in the uncompressed format; and
re-encoding the media content in the uncompressed format to generate the first segment.

5. The method of claim 4, wherein a first watermarking detection period of the first segment is greater than a playback duration of the first segment.

6. The method of claim 4, wherein a second watermarking recognition period of second first segment is greater than a playback duration of the second segment.

7. The method of claim 1, wherein the making available comprises transmitting the concatenated media content over a network connection.

8. The method of claim 1, wherein the making available comprises writing the content to a playback media.

9. An apparatus for redistributing media content, comprising:
a first receiver for receiving a first segment of the media content;
a second receiver for receiving a second segment of the media content; and
a storage device for storing the first segment of the media content from the first receiver and the second segment of the media content from the second receiver as a concatenated media content.

10. The apparatus of claim 9, wherein the storage device uses an index file, wherein the index file comprises a first index associated with the first segment and a second index associated with the second segment.

11. The apparatus of claim 10, wherein the index file is used to determine an ordering of the segments in the concatenated media content.

12. The apparatus of claim 9, wherein a watermark payload is associated with the media content, and wherein the watermark payload comprises a first period of time of a watermarking detection period.

13. The apparatus of claim 12, wherein the first segment comprises a second period of time of the media content that is shorter than the first period of time of the media content.

14. The apparatus of claim 12, wherein the second segment comprises a third period of time of the media content that is shorter than the first period of time of the media content.

15. The apparatus of claim 9, further comprising:
at least one additional receiver for receiving at least one additional segment of the media content, and wherein the concatenated media content further includes the at least one additional segment of the media content.

16. A non-transitory machine readable storage medium encoded with instructions for performing a method of redistributing media content, said instructions comprising:
instructions to receive, using a first receiver, a first segment of the media content;
instructions to receive, using a second receiver, a second segment of the media content;
instructions to store, using a storage device, the first segment and the second segment; and
instructions to make the first segment of the media content from the first receiver and the second segment of the media content from the second receiver available to a client as a concatenated media content.

17. The non-transitory machine readable storage medium of claim 16, wherein the instructions to make comprises, instructions to use an index file, wherein the index file comprises a first index associated with the first segment and a second index associated with the second segment.

18. The non-transitory machine readable storage medium of claim 17, wherein the index file is used to determine an ordering of the segments in the concatenated media content.

19. The non-transitory machine readable storage medium of claim 16, wherein a watermark payload is associated with the media content, and wherein the watermark payload comprises a first period of time of the media content.

20. The non-transitory machine readable storage medium of claim 19, wherein the first segment comprises a second period of time of the media content that is shorter than the first period of time of the media content.

21. The non-transitory machine readable storage medium of claim 19, wherein the second segment comprises a third period of time of the media content that is shorter than the first period of time of the media content.

22. The non-transitory machine readable storage medium of claim 16, wherein the instructions to make comprises instructions to transmit the concatenated media content over a network connection.

23. The non-transitory machine readable storage medium of claim 16, wherein the instructions to make comprises instructions to write the content to a playback media.
